(19) United States
(12) Patent Application Publication
(10) Pub. No.: US 2016/0188171 A1
(43) Pub. Date: Jun. 30, 2016

(54) SPLIT BUTTON WITH ACCESS TO PREVIOUSLY USED OPTIONS

(71) Applicant: Microsoft Technology Licensing, LLC., Redmond, WA (US)

(72) Inventors: Amani Ahmed Dye, Bothell, WA (US); Julie Christa Seto, Duvall, WA (US); Maya Rodrig, Seattle, WA (US); Erez Kikin-Gil, Bellevue, WA (US); Taili Feng, Bellevue, WA (US); Denys Krut, Redmond, WA (US); Vlad Riscutia, Redmond, WA (US); Alicia Kyle Drummond, Seattle, WA (US)

(73) Assignee: Microsoft Technology Licensing, LLC., Redmond, WA (US)

(21) Appl. No.: 14/701,061

(22) Filed: Apr. 30, 2015

Related U.S. Application Data
(60) Provisional application No. 62/098,982, filed on Dec. 31, 2014.

(51) Int. Cl. G06F 3/0484; G06F 3/0481; G06F 3/0482

(52) U.S. Cl. CPC G06F 3/04842; G06F 3/0482; G06F 3/04817

(57) ABSTRACT

A split button user interface component for accessing previously used functions and attributes is provided. Selection of a first or menu section of the interface component causes the launching of a menu or gallery of functions or attributes that may be applied to a given object, data item or displayed range. Upon selection of a given function or attribute from a launched menu or gallery, the selected function or attribute is applied to the given object, data item or displayed range. After dismissal of the launched menu or gallery, the second or executable section of the split button user interface component is updated to show a visual representation of the selected function or attribute. Subsequent selection of the executable section of the split button user interface component causes an automatic application of the last selected function or attribute to a desired object, data item or displayed range.

### CROSS REFERENCE TO RELATED APPLICATIONS

The application claims the benefit of U.S. Provisional Patent Application No. 62/098,982, titled “Split Button with Access to Previously Used Options” filed Dec. 31, 2014.

### BACKGROUND

In a typical computer-generated user interface, one or more top level buttons or controls are provided that allow a user to launch a menu or gallery of selectable functions or attributes to apply to a selected object, data item or displayed range. In such cases, a user often launches a menu or gallery followed by browsing the offerings in the menu or gallery. After the user selects a given function from the menu or gallery, the selected function is applied to the object, data item or range, and the launched menu or gallery is then dismissed from view. For example, a user may desire to apply a color, font, object style or the like to a given range of data. In such cases, the user often desires to apply the same function or attribute to a subsequent object, data item or range. Unfortunately, when the user decides on a subsequent object, data item or range for application of the function or attribute, the user must repeat the process of launching the menu or gallery, browsing for the desired function or attribute, followed by selection of the desired function or attribute to apply to the subsequent object, data item or range.

Unfortunately, such a process is time-consuming, often frustrating to the user, and is very inefficient from a computing processing, memory and battery life standpoint. In terms of time consumption, the user may often spend a significant amount of time launching a menu and browsing for a desired function or attribute, for example, 10-30 seconds. When multiplied by the many times a user may be required to browse for a desired function or attribute during the editing of a given document such time consumption may amount to a great deal of lost time and inefficiency for the user. For example, if a user applied a red color to a text range in a document, and the user subsequently desires to apply the same red color to a different text range in the same document, possibly several pages away from the last use of the red color, the user must browse through a menu of colors and try to remember the precise red color to select from a variety of reddish colors which leads to additional time loss and inefficiency in selecting the appropriate color. Such a process is not only time consuming but is frustrating to the user if the user has difficulty locating the same function or attribute applied to the last object, data item or range.

In terms of computer inefficiency, such a process is very inefficient from a computing processing, memory and battery life standpoint. For example, each time a user is required to launch a menu to browse for the desired function or attribute, the computer must exhaust valuable processing time in rendering the menu or gallery a subsequent time which can be exacerbated by the rendering of complex items in a menu or gallery such as colors, color patterns, object shapes and styles, and the like. Moreover, each such rendered menu or gallery must be at least temporarily committed to memory during the time the user is browsing the rendered menu or gallery. In the case of small form devices, such as mobile telephones, tablet style computers, and the like operating on limited battery capacity, such processing and memory consumption costs valuable battery resources and wear and tear on the computing device.

It is with respect to these and other considerations that the present disclosure will be made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Aspects of the present disclosure solve the above and other problems by providing a split button user interface component for accessing previously used functions and attributes. According to one aspect, a split button user interface component is provided for accessing one or more functions or attributes for application to an object, data item, displayed range, or like selection of content. The split button user interface component is split into two sections. Selection of a first or menu section causes the launching of a menu or gallery of functions or attributes that may be applied to a given object, data item or displayed range. Upon selection of a given function or attribute from the launched menu or gallery, the selected function or attribute is applied to the given object, data item or displayed range, and the launched menu or gallery is dismissed.

After dismissal of the launched menu or gallery, the second or executable section of the split button user interface component is updated to show a visual representation of the selected function or attribute. Subsequent selection of the executable section of the split button user interface component causes an automatic application of the last selected function or attribute to a desired object, data item, displayed range, or like selection of content. Thus, the user does not need to launch the menu or gallery a subsequent time to find the last used function or attribute.

According to another aspect, in addition to including a visualization of the last selected function or attribute in this section of the split button user interface component, a selectable visualization (e.g., selectable icon) may be provided for other functions or attributes such as one or more most recently used functions or attributes, one or more most often used functions or attributes, one or more most popular functions or attributes, or a combination thereof.

According to another aspect, a computing device with improved efficiency is provided. The improved computing device includes operating components for computer processing and information rendering and display, as well as, software or hard-coded executable instructions for providing a split button user interface component summarized above. By providing the split button user interface component, the computing device operates more efficiently by greatly reducing rendering and display processing resources, memory and battery life costs associated with browsing for functions and attributes provided in a launched menu or gallery.

The details of one or more aspects are set forth in the accompanying drawings and description below. Other features and advantages will be apparent from a reading of the following detailed description and a review of the associated drawings. It is to be understood that the following detailed description is explanatory only and is not restrictive.

### BRIEF DESCRIPTION OF THE DRAWINGS

FIG. 1 is a simplified block diagram of a computer-generated user interface displayed on a mobile computing device showing one or more selectable functions or controls including a split button user interface component.

FIG. 2 is a simplified block diagram illustrating components of a split button user interface component.

FIG. 3A is a simplified block diagram of a computer-generated user interface displayed on a mobile computing device showing a selected data range for application of a given function or attribute.

FIG. 3B is a simplified block diagram of a computer-generated user interface displayed on a mobile computing device showing selection of a menu or gallery section of a split button user interface component.

FIG. 3C is a simplified block diagram of a computer-generated user interface displayed on a mobile computing device showing a launched menu of selectable functions or attributes for application to a given object, data item or displayed data range.

FIG. 3D is a simplified block diagram of a computer-generated user interface displayed on a mobile computing device showing a launched menu of selectable functions or attributes for application to a given object, data item or displayed data range and showing selection of a desired function or attribute.

FIG. 3E is a simplified block diagram of a computer-generated user interface displayed on a mobile computing device showing application of a selected function or attribute and showing updating of the split button user interface component.

FIG. 3F is a simplified block diagram of a computer-generated user interface displayed on a mobile computing device showing a second object, data item or range for application of a selected function or attribute.

FIG. 3G is a simplified block diagram of a computer-generated user interface displayed on a mobile computing device showing selection of an executable section of a split button user interface component.

FIG. 3H is a simplified block diagram of a computer-generated user interface displayed on a mobile computing device showing selection of an executable section of a split button user interface component and showing application of a selected function or attribute to an example data range.

FIG. 3I is a simplified block diagram of a computer-generated user interface displayed on a larger form display screen showing provision of a split button user interface component in a ribbon-style user interface.

FIG. 3J is a simplified block diagram of a computer-generated user interface displayed on a larger form display screen illustrating a split button user interface component in a callout menu displayed as a drop-down from a ribbon-style user interface.

FIG. 4 is a simplified block diagram of a computing device for providing a split button user interface component.

FIG. 5 is a flowchart showing a method for providing a split button user interface component.

FIG. 6 is a block diagram illustrating example physical components of a computing device with which aspects may be practiced.

FIGS. 7A and 7B are simplified block diagrams of a mobile computing device with which aspects may be practiced.

FIG. 8 is a simplified block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims.

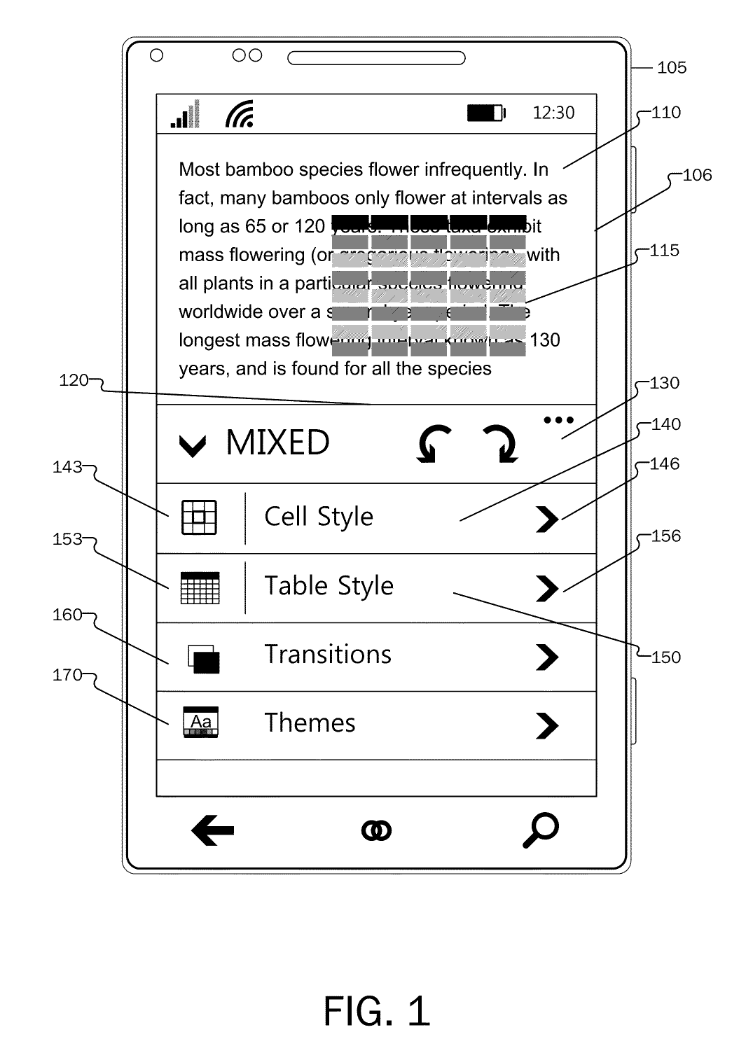

As briefly described above, aspects are directed to a split button user interface component for accessing previously used functionalities and attributes. FIG. 1 is a simplified block diagram of a computer-generated user interface displayed on a mobile computing device showing one or more selectable functions or controls including a split button user interface component. As illustrated in FIG. 1, a mobile computing device 105 is illustrative of a mobile telephone, tablet style computing device, any handheld computing device, or the like. As should be appreciated, the illustration of a mobile or handheld computing device 105 is for purposes of illustration and example only and is not limiting of utilization of aspects described herein with respect to other computing devices such as desktop computing devices, laptop computing devices, wall type computing devices, projection type computing devices, and the like.

Referring still to FIG. 1, the handheld computing device 105 includes a display surface 106 onto which may be displayed software application user interfaces of various types including interfaces for telephone, messaging, electronic mail, calendaring, word processing, slide presentation, spreadsheets, data management, or any other software application that may utilize a displayed user interface for allowing a user to interact with the associated functionality. As illustrated in FIG. 1, an example software application user interface for displaying, entering, editing, and otherwise interacting with text 110 is illustrated.

Beneath the illustrated text 110 is a palette 120 of user interface components including a variety of selectable buttons and controls for interacting with the functionality of the associated software application. For example, a first user interface component 130 includes a variety of functionality controls for manipulating a display of the displayed text 110 and for accessing and utilizing other functionalities provided by the associated software application such as save functionalities, send functionalities, formatting functionalities, and the like. In various examples, the palette 120 may not be provided until a document object is selected, thereby preserving screen space for viewing the document. In other examples, the user interface components included within the palette 120 may be adjusted based on the type of document object selected or present in the document (e.g., a table, a range of text, a range of cells, an image, etc.).

Referring still to the palette 120 of user interface components, two split button user interface components 140 and 150 are illustrated and two non-split button user interface components 160 and 170 are illustrated. According to aspects, each of the user interface components 140, 150, 160, 170 is associated with one or more functionalities or attributes of the associated software application for application to a given object, data item, or displayed range. For example, the split button user interface component 140 is associated with cell styles that may be selected for application to a block of data 115 illustrated overlying the text 110. The split button user interface component 140 is illustrated as including a function executable section 143 to, for example, apply the previously selected style, and a menu section 146 to, for example, enable the user to select or designate a (different) style to apply to the cells. Similarly, the split button user interface component 150 is associated with an example table style functionality that may be selectively applied to the data 115 according to the table style illustrated by function executable section 153 or according to a style selected/designated by the user via menu section 156. The example non-split button user interface components 160 and 170 are associated with transitions and themes functionalities and attributes that may be applied to the data 115, or to the text 110 underlying the data 115.

As should be appreciated, the user interface components illustrated in the palette 120 of user interface components (e.g., buttons and controls) illustrated in FIG. 1 are for purposes of example and are not limiting of the exhaustive numbers of functionality buttons and controls that may be displayed in a palette 120 of functionality buttons and controls. That is, for a word processing application, functionality buttons and controls for applying word processing type functionalities and attributes to a selected object, data item or range may be provided, for a spreadsheet application, buttons and controls for applying spreadsheet application functionality to a given object, data item or data range may be provided, for a slide presentation application, buttons and controls for applying slide presentation application functionality and attributes to a given object, data item or data range may be provided, and so on. That is, for any software application launched by the computing device 105 and provided in a user interface such as illustrated in FIG. 1, selectable buttons and controls, including the split button user interface components described herein, may be provided in association with the software application functionality in use.

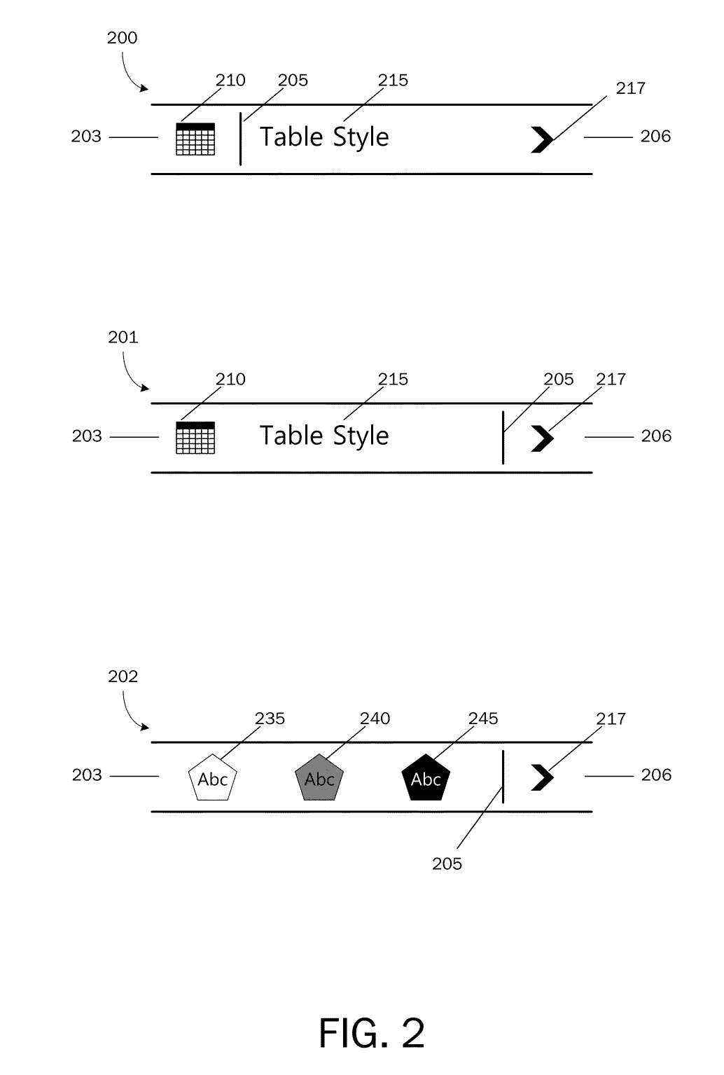

FIG. 2 is a simplified block diagram illustrating components of a split button user interface component. At the top of FIG. 2, an example of a split button user interface component 200 is illustrated. The split button user interface component 200 is divided into a selectable function executable section 203 and a selectable menu section 206. As briefly described above, selection of the menu section 206 causes the launching of a menu or gallery containing one or more selectable functions or attributes that may be applied to a given document object, data item or range in association with the identified functionality type. Such a document object may include text, spreadsheet data, images, photographs or any other object to which a function (e.g., an editing function) or attribute (e.g., a formatting attribute) may be applied.

In the menu section 206 illustrated at the top of FIG. 2, a text string 215 of “Table Style” is provided for alerting a user that selection of this menu section 206 from the user interface component 200 will cause the launching of a menu or gallery of selectable functionalities and/or attributes associated with table styles for allowing a user to selectively apply one or more table styles to a range of data. According to an aspect, the text string 215 included in the menu section 206 may be dynamically changed after the selection of a particular functionality or attribute from a launched menu or gallery to reflect the selected functionality or attribute. For example, if the text string 215 included the words “Graph Type,” and a user selected a bar graph from a launched menu or gallery, the text string 215 may be dynamically updated to include the words “Bar Graph” instead of the words “Graph Type” to further indicate to the user information about the last used functionality or attribute from the launched menu or gallery of functionalities or attributes. In some aspects, the text string 215 may be omitted, for example, to save space on a display screen when the size of the display screen fall below a threshold or when the visualization 210 renders the text string 215 superfluous (e.g., includes a text description or whose function is clearly indicated).

In addition to the text string 215, a chevron 217 is illustrated for alerting the user as to a direction or location in the user interface at which the launched menu or gallery will be provided if the menu section 206 is selected. That is, as illustrated in FIG. 2, the chevron 217 alerts the user that a subsequently launched menu or gallery of functionalities or controls will be launched to the right of the selected menu section 206. Thus, if the chevron 217 is pointing in a downward direction, then the user will be alerted that a launched menu or gallery will be displayed beneath the selected menu section 206, and so on. Referring still to the user interface component 200, a separator 205 is illustrated for alerting the user that the user interface component 200 is a split button user interface component and that the executable section 203 is associated with, but separate from, the menu section 206.

According to an aspect, a visualization 210 is provided in the executable section 203 that shows a visualization of the last functionality or attribute applied using the user interface component 200. For example, the visualization 210 is a visualization of a certain type of table style that was previously applied to a range of data. As will be described below, each time a given functionality or attribute is selected from a launched menu or gallery of functionalities or attributes, the visualization 210 contained in the executable section 203 of the split button user interface component 200 is updated to reflect the last used functionality or attribute for alerting the user as to the nature of the last used functionality or attribute. According to aspects, the visualization 210 may represent a current state of a selected object, for example, when no functionality or attribute has been previously selected for a given split button user interface component 200.

According to aspects, selection of the executable section 203 causes an automatic application of the functionality or attribute last utilized and represented by the visualization 210 to a given document object, data item or range. For example, if a given table style were last selected from a launched menu or gallery of table styles in response to a selection of the menu section 206, then the visualization 210 will be updated to represent the last utilized functionality or attribute. If the user desires to apply the same functionality or attribute to a subsequent range of data, the user need not launch the menu or gallery again, but instead, the user need only select the executable section 203 of the user interface component 200 for automatically applying the last utilized functionality or attribute to the subsequent range of data. Thus, the user is not required to repeat the process of launching the menu or gallery of functionalities or attributes each time the user desires to utilize the last used functionality or attribute.

Referring still to FIG. 2, the second illustration of the user interface component 201 illustrated in the middle of FIG. 2 shows an alternate display orientation of the split button user interface component. According to this display orientation, the executable section 203 utilizes significantly more space in the user interface component 200 than the associated menu section 206. According to this orientation, the descriptive text string 215 and the visualization 210 are both contained in the executable section 203 and are utilized for alerting the user as to the nature of the last used functionality or attribute, as described above. In some examples, the orientation of the user interface component 200 is changed to that of user interface component 201 in response to receiving a selection of a function from the menu/gallery. In this illustrated example, the separator 205 continues to separate the executable section 203 from the menu section 206, and the chevron 217 or other directional indicator for indicating a direction and/or location of a launched menu or gallery of functionalities or attributes is illustrated in the menu section 206, as described above.

Referring now to the example split button user interface component 202 illustrated at the bottom of FIG. 2, another alternate orientation of the split button user interface component is illustrated and described. Referring to the user interface component 202, an executable section 203 is separated from a menu section 206 by a separator 205, as described above. However, according to the user interface component 202 illustrated in FIG. 2, a plurality of selectable icons 235, 240, 245 are illustrated in the executable section 203. According to this aspect, the executable section 203 may be populated with selectable icons associated with other types of previously used functionalities and/or attributes for providing a user with additional selectable functionalities or attributes to apply to a given object, data item or range. For example, each of the selectable icons 235, 240, 245 may represent visualizations of the top n (e.g., top three) most recently used functionalities or attributes applied to a given object, data item or range. For example, the icon 235 may be colored green, the icon 240 may be colored red, and the icon 245 may be colored black to provide visual indications that, according to the prior user history, the most recently used colors applied to an object, data item or range were green, red, and black, respectively.

Alternatively, each of the illustrated icons may include the top n (e.g., top three) most popular functionalities or attributes used from a given launched menu or gallery where popularity is tracked on the number of uses of a given functionality or attribute across one or more sessions of use of the associated software application across one or more users either as stand-alone users or users in a network of users based on their combined user histories. Alternatively, the selectable icons 235, 240, 245 may represent a combination of previously used functionalities and/or attributes. For example, the first icon 235 may represent the last functionality or attribute utilized, the icon 240 may represent the most recently used functionality or attribute utilized by one of a team or group of users, and the icon 245 may illustrate a most popular functionality or attribute used by one or more users, as described above.

The arrangement of the icons 235, 240, 245 may be ordered according to one or more ordering attributes. For example, if each of the three icons are associated with the most recently used functionalities and/or attributes, then the ordering may include a left to right ordering for most recently used followed by next most recently used followed by next most recently used and so on. Thus, the ordering of the displayed selectable icons may be arranged in any manner that assists in the logical selection of an associated functionality or attribute. Accordingly, a user may selectively apply a functionality and/or attribute to a desired object, data item or range of data by selecting one of the provided selectable icons without the need for launching a menu or gallery of functionalities and/or attributes followed by browsing or searching for a desired functionality or attribute.

Referring back to FIG. 1, as illustrated and described above, non-split button user interface components 160 and 170 are provided for allowing a user to selectively apply one or more functionalities or attributes to a given object, data item or range, or for allowing a user to launch a menu or gallery of functionalities and/or attributes that may be applied, as desired. According to an aspect, a non-split button user interface component 160, 170 may be transformed into a split button user interface component (similar to split button user interface components 140, 150) after a first selection of a functionality or attribute from a launched menu or gallery of functionalities and/or attributes. For example, if the non-split button user interface component 160, illustrated in FIG. 1, is associated with a menu or gallery of functionalities and/or attributes, that has not previously been used by a user of the associated software application, then no last used functionality or attribute or no most frequent or most popular functionality or attribute may be available for applying to an executable section 203, as described above.

In such a case, a non-split button user interface component 160, 170 may be provided for allowing a user to launch a menu or gallery of functionalities or attributes by selection of the non-split button user interface component. Then, when the user selects a given functionality or attribute from a launched menu or gallery, as described herein, upon dismissal of the launched menu or gallery, the non-split button user interface component 160, 170 may be transformed into a split button user interface component wherein a separator 205 will be deployed between an executable section 203 and a menu section 206, and wherein a visualization 210 associated with the selected functionality or attribute may be applied to the executable section 203. In addition, one or more identifying features, for example, a text string 215 and chevron 217 may be applied to the menu section 206, as described above with reference to FIG. 2.

According to this aspect, if such a split button user interface component is generated after a first use of a launched menu or gallery, the generated split button user interface component may remain as a split button user interface component indefinitely. Alternatively, if a threshold number of uses of the associated software application occur without use of the generated split button user interface component (i.e., a non-use threshold is met), the split button user interface component may be transformed back into a non-split button user interface component and a visualization associated with a last used, most frequently used or most popularly used functionality or attribute may be removed or replaced with a visualization representative of the menu/gallery of functions. In such a case, it may be advantageous to demote a generated split button user interface component to a non-split button user interface component if enough uses of the associated application are encountered without use of the generated split button user interface component because the last used, most frequently used, or most popularly used functionality or attribute may lose meaning to the user. For example, even though a user utilized a red coloring for highlighting a text entry two months ago when that functionality was last used, the user may not have any desire to use that same red coloring in a subsequent use, and thus, requiring the user to launch the menu or gallery of colors may be advantageous. As should be appreciated, the demotion of a split button user interface component to a non-split button user interface component may be applied to any split button user interface component whether it were initially generated from a non-split button user interface component or not.

According to an aspect, a software module or a hard-coded executable instruction model may be provided for tracking usage of functionalities and/or attributes from all available menus of functionalities and/or attributes and for generating, displaying, and arranging the components the split button user interface component, including for ordering the selectable icons 235, 240, 245 in a user interface component 202, illustrated in FIG. 2. Such usage tracking may also be used for transforming a non-split button user interface component to a split button user interface component and vice versa, as described above.

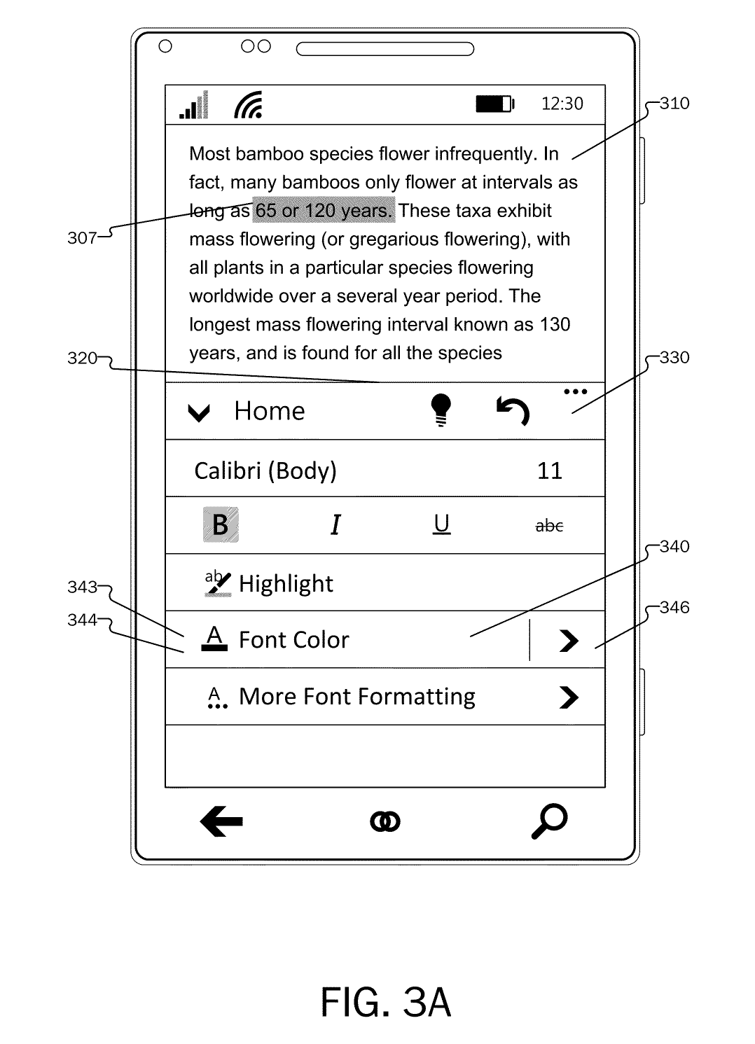

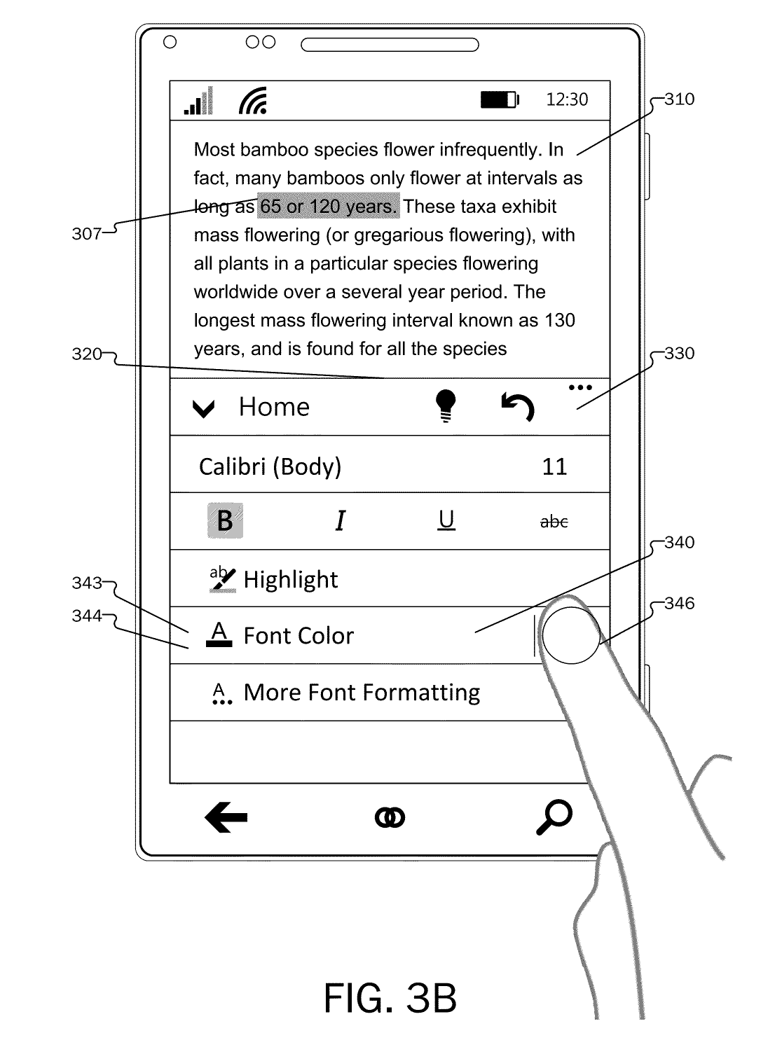

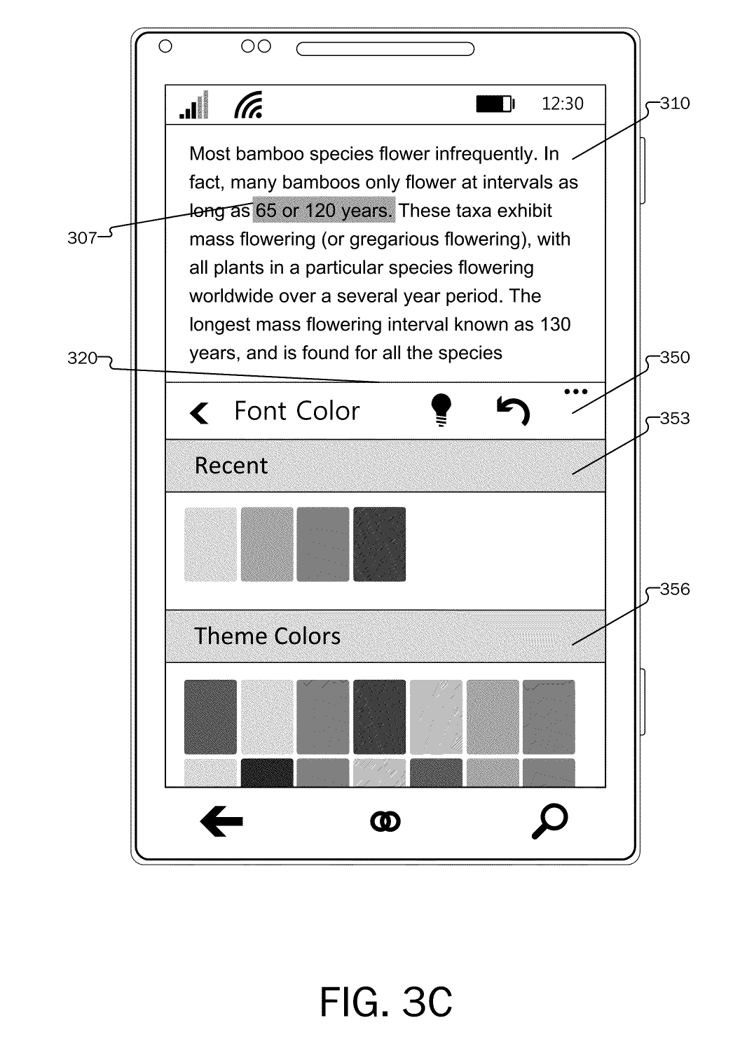

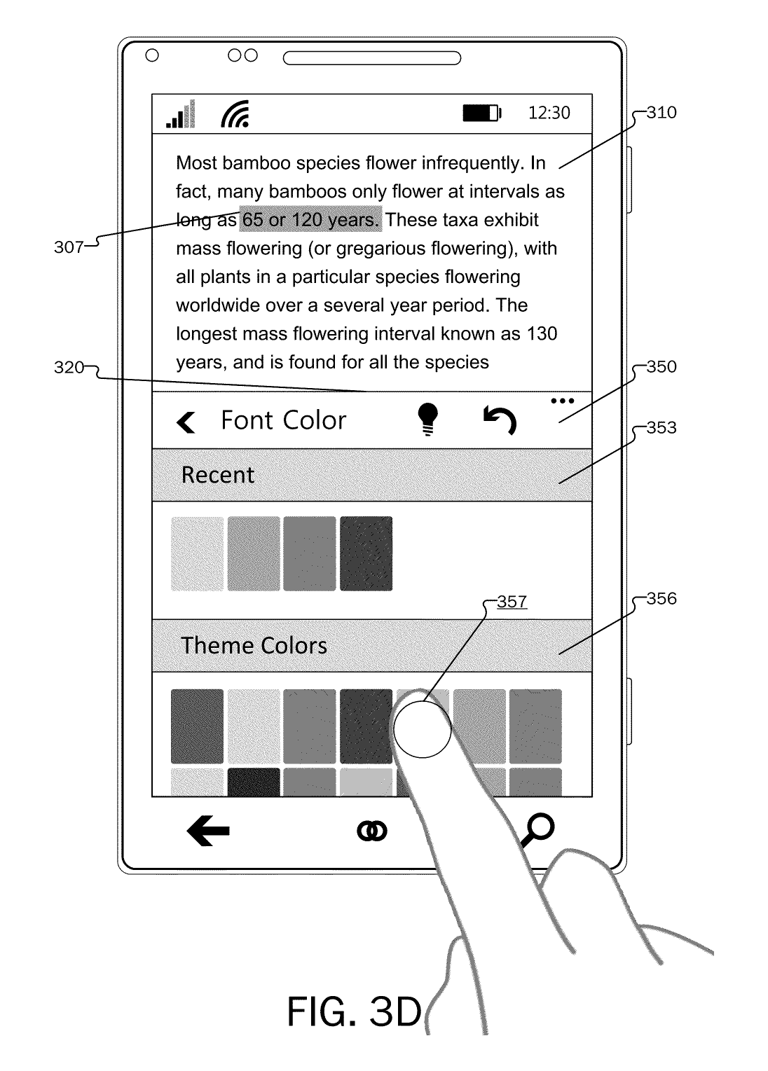

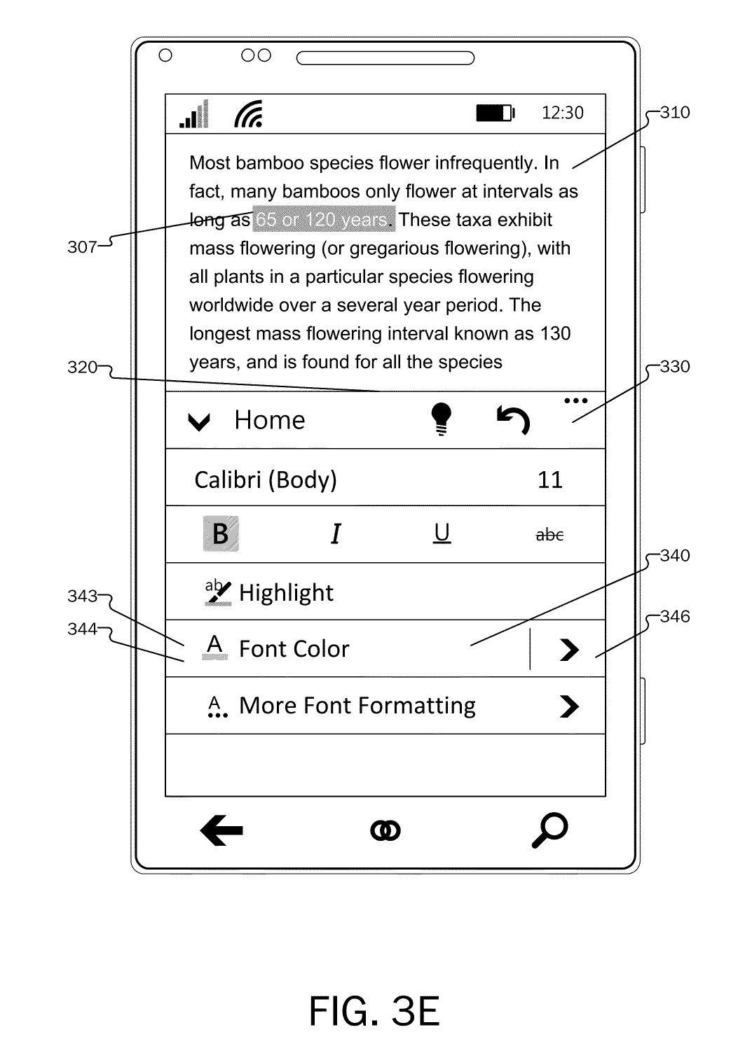

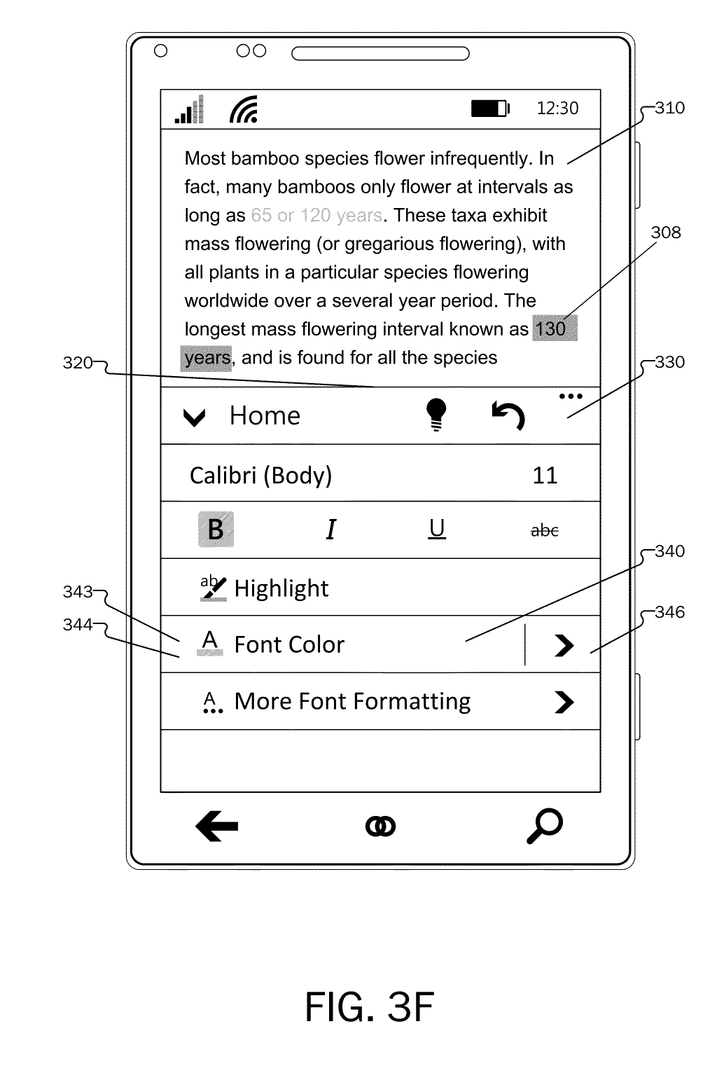

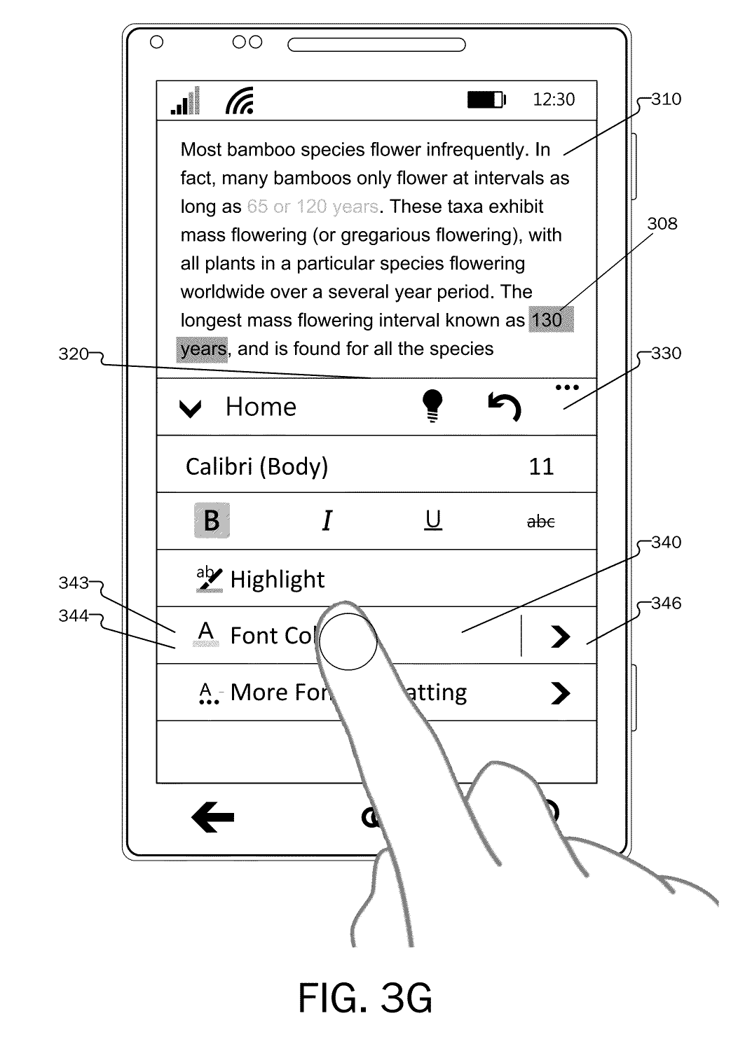

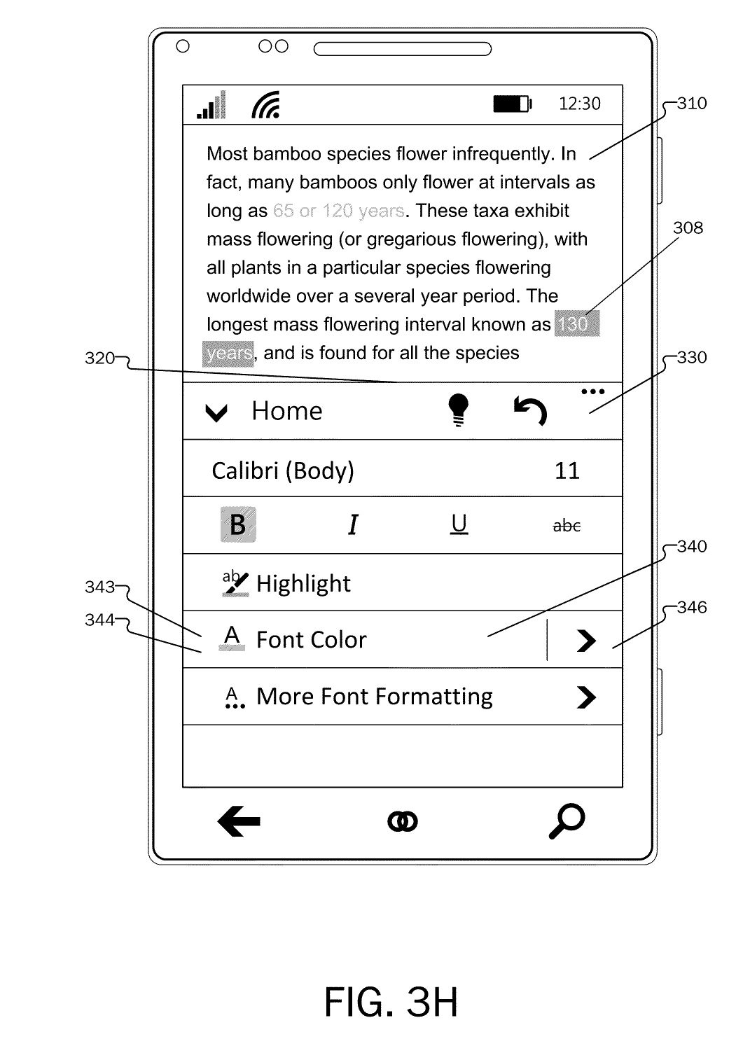

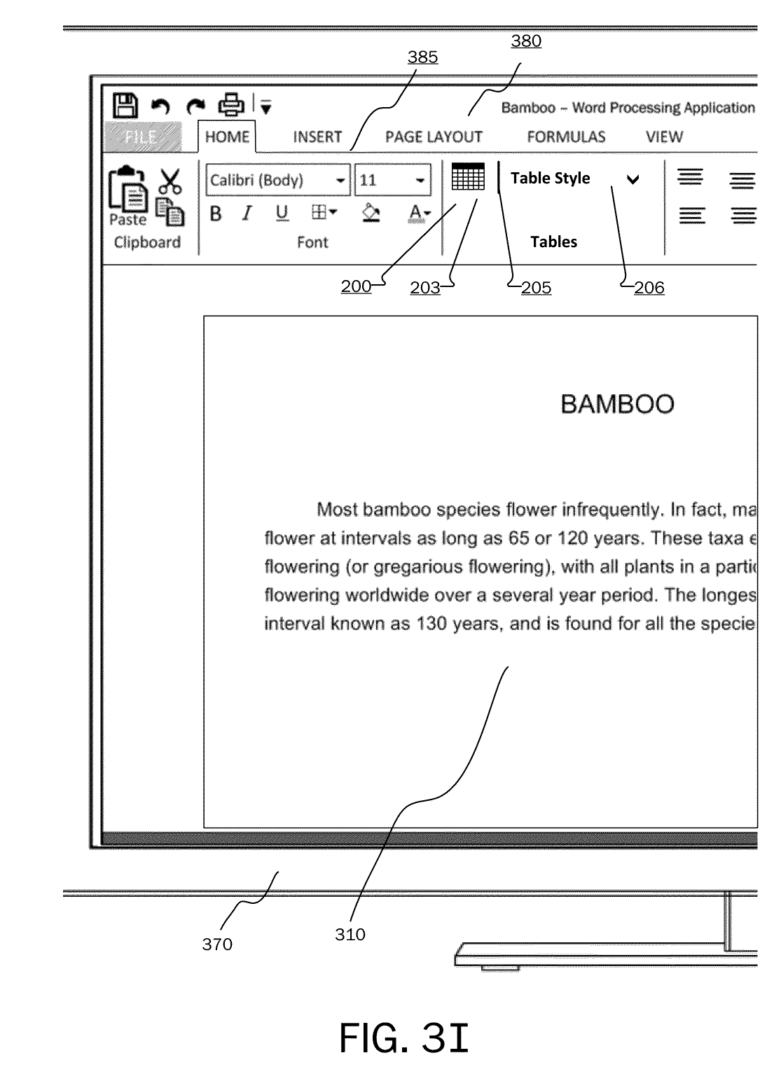

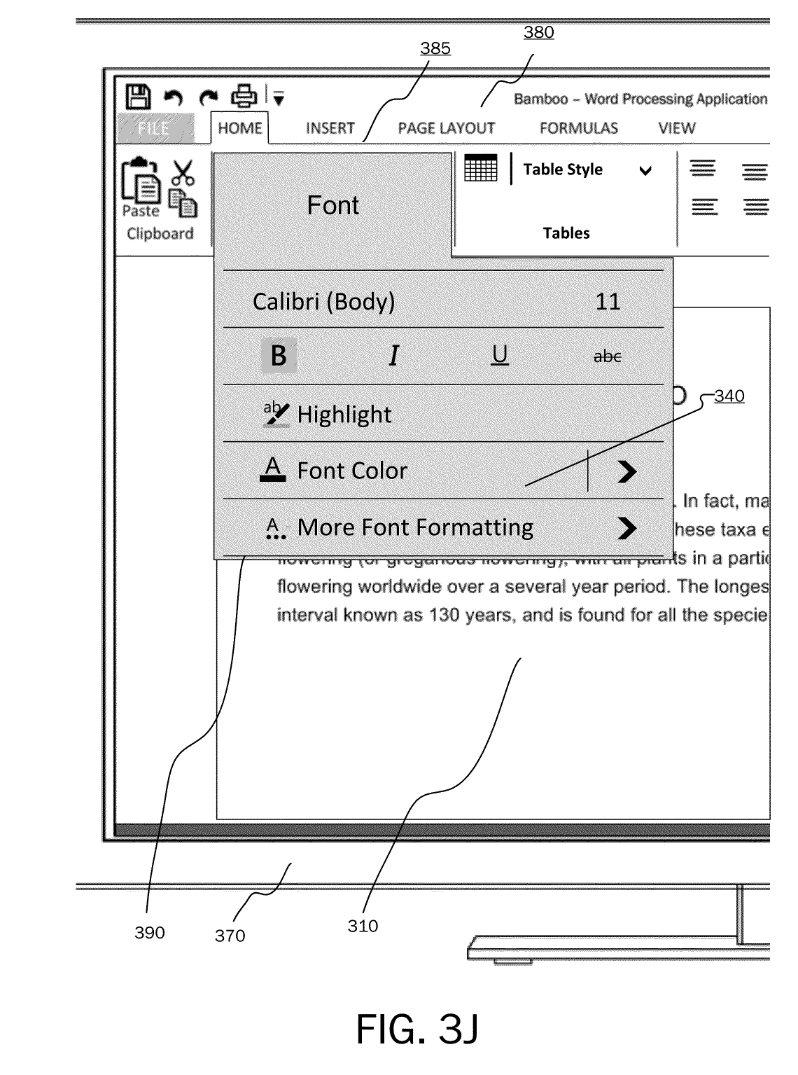

Referring now to FIGS. 3A through 3H, an example use sequence for a split button user interface component 340 is illustrated and described. Referring then to FIG. 3A, an example text selection or text range 307 within application content 310 is illustrated as having been selected for application of a desired functionality or attribute. A split button user interface component 340 is illustrated in the palette 320 of user interface components having an executable section 343 and a menu section 346. Referring to the executable section 343, the text string of “Font Color” indicates to a user that selection of this user interface component will allow application of one or more font colors to a given object, data item or range of data Immediately to the left of the text string “Font Color” is a letter “A” underlined by a color swatch 344. According to aspects, the color swatch 344 underlining the letter “A” will be colored according to the last font color applied to a given object, data item or data range. If a user desires to automatically apply the last font color applied as indicated by the underlying visualization of the color swatch 344, then the user need only select the executable section 343 of the split button user interface component 340 to automatically apply the last used font color to the text selection 307. Alternatively, if a user desires to utilize a different font color for the present application, then the user may select the menu section 346 for launching a menu or gallery of additional font colors from which the user may select.

Referring to FIG. 3B, selection of the menu section 346 is illustrated, and in FIG. 3C, a menu or gallery of colors 350 is provided in the palette 320 of user interface components overlaying or replacing the display 330 of the user interface components previously displayed in the palette 320, as illustrated in FIG. 3B. A set of “recent colors” 353 are provided and a set of “theme colors” 356 are provided. As should be appreciated, the example menu/gallery of colors 350 is for purposes of example only and is not exhaustive of the vast numbers, varieties, and types of functionalities and/or attributes that may be provided in a menu or gallery from which a user may select for applying to a given object, data item or data range.

Referring now to FIG. 3D, a selection of a particular color 357 is illustrated, and the selected color 357 is automatically applied to the text selection 307, as illustrated in FIG. 3E. In addition, the color swatch 344 underlying the character “A” displayed in the executable section 343 of the split button user interface component 340 is dynamically changed to the selected color 357 to indicate to a user the last color applied to a selected text range. Referring to FIG. 3F, if the user desires to apply the same color to additional text ranges 308, objects or data items contained in the example document, the user need only select the executable section 343, as illustrated in FIG. 3G, and the last utilized color, according to this example, will be automatically applied, as illustrated in FIG. 3H.

Referring now to FIG. 3I, a split button user interface component 200 is illustrated in a ribbon-style array 385 of user interface components illustrated in a larger form computer display screen, such as is found in desktop and laptop computing devices 370. According to an aspect, code running on the computing device responsible for displaying a software application user interface 380 may track the computer display screen size and may evaluate space availability for displaying various user interface components. If it is determined that the display space is insufficient for displaying the ribbon-style array 385 of user interface components illustrated in FIG. 3I, then a palette 320 of user interface components as illustrated in FIGS. 3A through 3H may be utilized. The utilization and functionality associated with the split button user interface component 200 illustrated in FIG. 3I is the same as described above with reference to FIGS. 1 through 3H. Accordingly, the computing device responsible for displaying a software application user interface 380 may track changes in display space size (e.g., increases, decreases, changes in aspect ratio, etc.) to convert the display of the split button user interface component 200 from a ribbon-style array 385 to a palette 320 and vice versa, for example, when a mobile device is connected to a projector-style display device or when a tablet device is rotated.

FIG. 3J illustrates a split button user interface component 340 in a callout menu 390 including user interface components, displayed in as a drop-down from a ribbon-style array 385 of user interface components. A callout menu 390 is a lightweight UI element that provides additional relevant contextual information and controls for an object, data item, or range in a document or application that invokes the callout menu 390. As illustrated, a callout menu 390 may be invoked as a drop-down from a ribbon-style array 385, for example, to provide more and/or larger controls on a touch interface than are provided via the ribbon-style array 385. In some aspects, the additional controls, including a split button user interface component 340, may be presented in the callout menu via a palette 320. The computing device responsible for displaying a software application user interface 380 may treat the callout menu 390 as a separate display, including a separate display space size, for determining whether to display the split button user interface component 340 in a ribbon-style array 385 or a palette 320 independently of the determination of whether to display the invoking document or application's software application user interface 380 as a ribbon-style array 385 or a palette 320.

As briefly described above, without the use of a split button user interface component as described herein, when the user decides to apply a previously used function or attribute to a subsequent object, data item or range, the user must repeat the process of launching the menu or gallery, browsing for the desired function or attribute, followed by selection of the desired function or attribute to apply to the subsequent object, data item or range. Unfortunately, such a process is very inefficient from a computing processing, memory and battery life standpoint. For example, each time a user is required to launch a menu to browse for the desired function or attribute, the computer must exhaust valuable processing time in rendering the menu or gallery a subsequent time, which can be exacerbated by the rendering of complex items in a menu or gallery such as colors, color patterns, object shapes and styles, and the like. Moreover, each such rendered menu or gallery must be at least temporarily committed to memory during the time the user is browsing the rendered menu or gallery. In the case of small form devices, such as mobile telephones, tablet style computers, and the like operating on limited battery capacity, such processing and memory consumption costs valuable battery resources and wear and tear on the computing device.

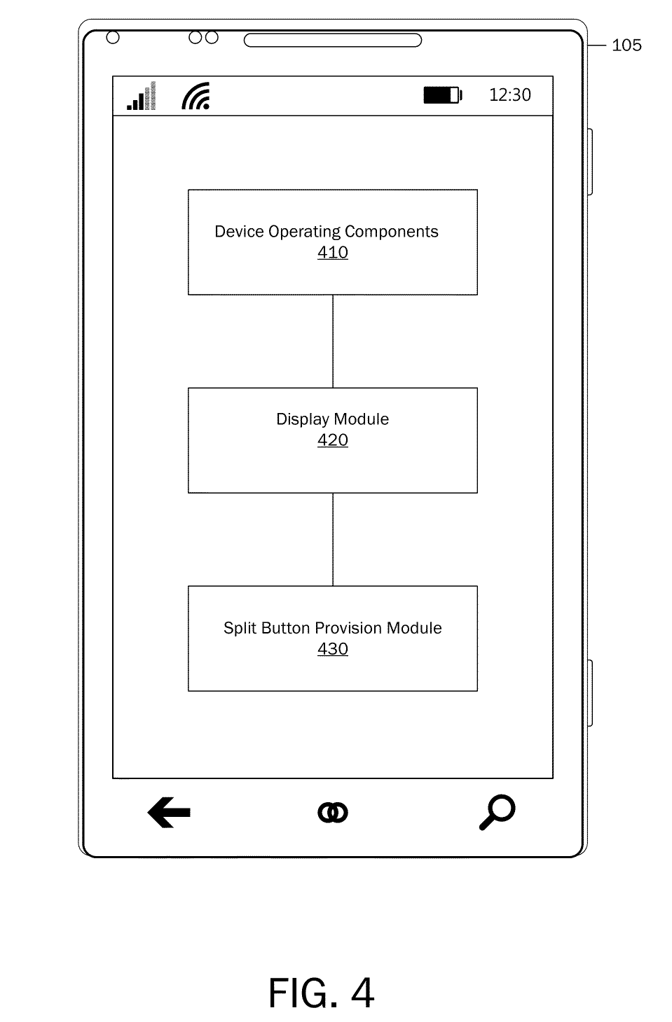

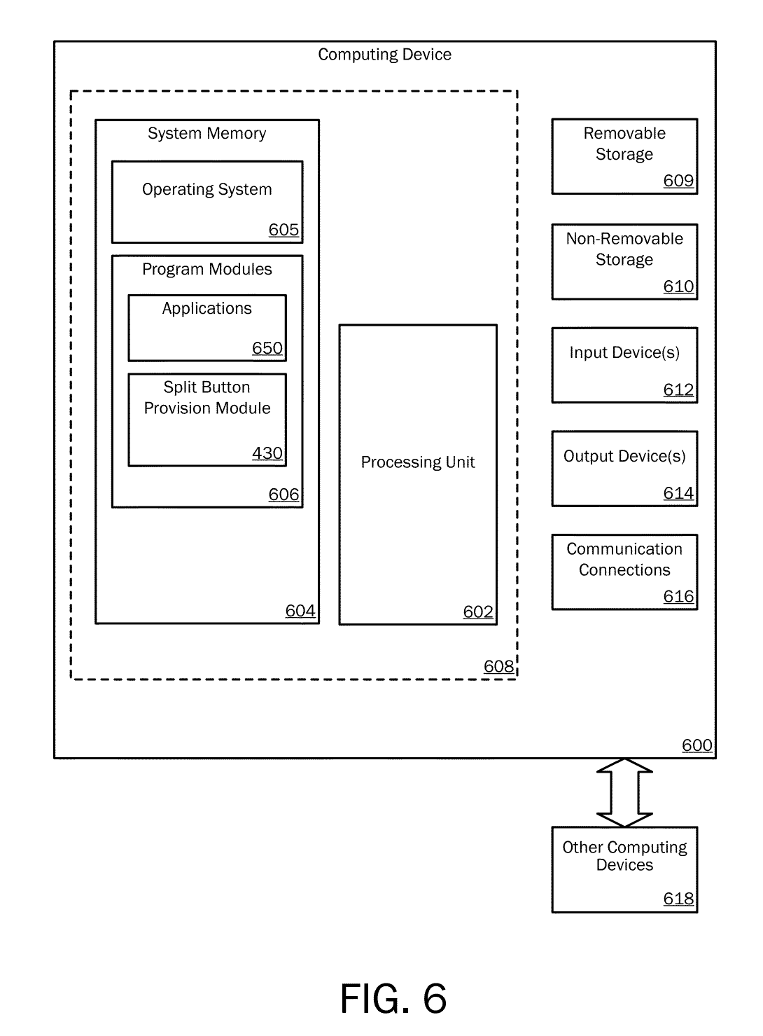

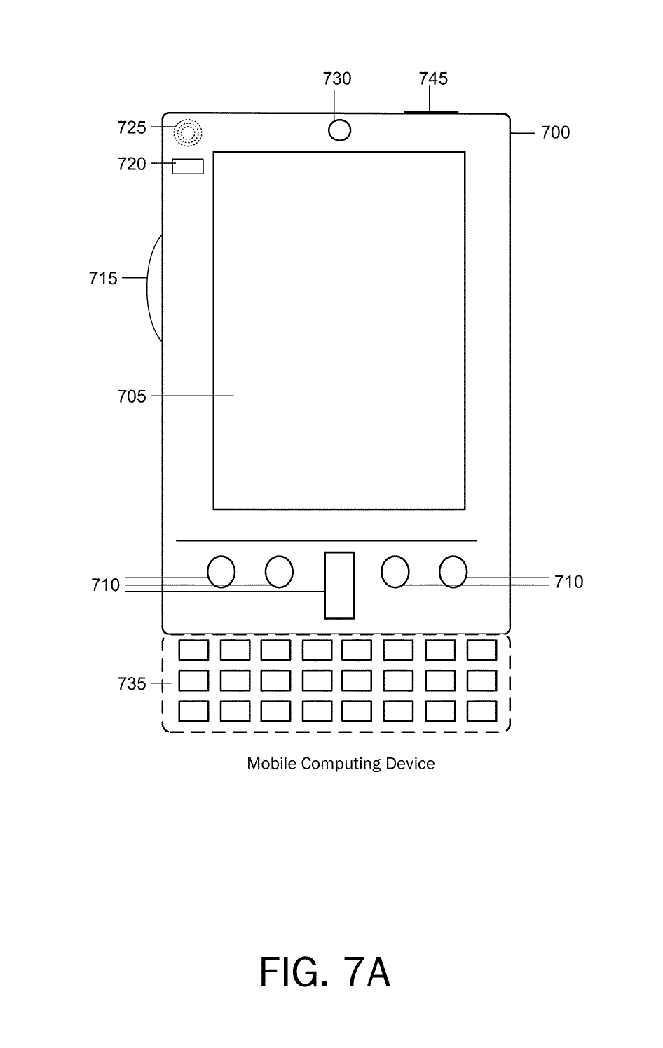

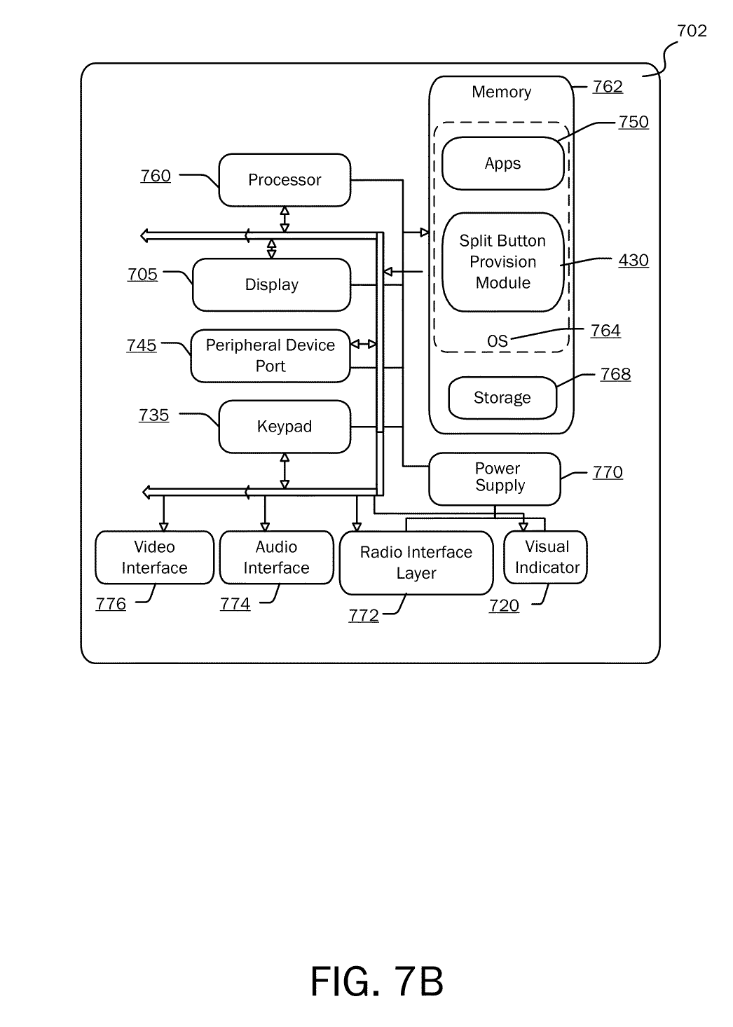

FIG. 4 is a simplified block diagram of a computing device for providing a split button user interface component. As illustrated in FIG. 4, a computing device 105 is illustrative of an improved computing device for providing a split button user interface component as described above for improving the operating efficiency of the computing device 105. The computing device 105 includes integrated device operating components for providing the computing device 105 with a variety of general purpose and specialized computing functions including electronic communications functions, telephonic communications functions, and including the operation of a variety of software applications such as word processing applications, spreadsheet applications, slide presentation applications, data management applications, and the like. A detailed description of the operating components 410 of the computing device 105 is provided below with reference to a general purpose computing device and with reference to a mobile computing device illustrated and described with reference to FIGS. 6 through 7B.

Referring still to FIG. 4, in addition to the device operating components 410, a display module 420 is provided for enabling the device 105 to render and display a variety of user interface components, objects, data items, text selections, and the like as enabled by one or more of a plurality of software applications within the available display space on a display device. A split button provision module 430 is provided for enabling the split button user interface component described above with reference to FIGS. 1 through 3I. According to one aspect, the split button provision module 430 is a software module loaded onto the device 105 or that may be called upon by the device 105 for providing the split button user interface component functionality described herein. Alternatively, the split button provision module 430 may be provided as a hard-coded executable instruction, for example, a module or system on a chip integrated with the other hardware components of the device 105.

In either case, when a software application is operating on or in association with the device 105, one or more processing threads may be operating at any given time for performing various functions of the software application. For example, such functions may include rendering and displaying a variety of user interface components, objects, data items, text selections, etc., associating the software application with functions of the device 105, and/or associating the device with peripheral devices that may be called upon by device 105, for example printers, and the like.

According to aspects, when a menu section of a split button user interface component is selected, as described above, an event associated with the selection is fired and is received by a processing thread associated with the split button provision module 430. In response, an associated menu or gallery is provided, and upon receipt of a selection of a function or attribute from a launched menu or gallery, a second event is received by the split button provision module 430 that, in turn, causes the selected functionality or attribute to be applied to a selected object, data item or data range, and that causes an automatic updating of the split button user interface component, including updating of a visualization 210 provided in the execution section of the split button user interface component 200, as described above. That is, each interaction with a split button user interface component, as described above, causes the firing of an event that is received by the split button provision module 430 and that, in turn, causes provision of the functionality associated with the split button user interface component, as described herein.

As described above, without the use of the split button user interface component, described herein, the computing device 105 is highly inefficient and receives excessive wear and tear because a user must selectively launch a menu or gallery each time the user desires an associated functionality or attribute followed by selection of a desired functionality or attribute, followed by dismissal of the launched menu or gallery, and so on. Such process must be repeated for each subsequent selection of the same functionality or attribute by the user. Each time the user selectively causes the launching of the menu or gallery, significant processing time is utilized in rendering the menu or gallery and for re-rendering the menu or gallery as the user scrolls through the menu or gallery. Such a rendering and re-rendering of the menu or gallery during scrolling and during each launching of the menu or gallery uses processing time, processing resources and at least temporarily utilizes memory associated with the device 105.

In addition, such processing and memory consumption expends limited battery life associated with the device 105. According to aspects, by eliminating the launching of a menu or gallery each time a user desires to apply the last used, most frequently used, most popularly used, and the like, which may be automatically accessed through the execution section of the split button user interface component, the efficiency of the device 105 is greatly enhanced and wear and tear on the device 105 by touch interaction, stylus interaction, key interaction, and the like is greatly reduced.

Having described various aspects with reference to FIGS. 1 through 4, FIG. 5 is a flowchart showing a method for providing a split button user interface component. The method 500 begins at start operation 505 and proceeds to operation 510 where an object, data item or range is selected in a displayed document or other file to which a user desires to apply a given functionality or attribute provided by an associated software application, for example, a word processing application. At operation 515, a selection of a split button menu section is received, and at operation 520, a menu or gallery of functionalities and/or attributes is displayed, as illustrated above with reference to FIG. 3C.

At operation 525, a selection of a functionality or attribute contained in the deployed menu or gallery is received. At operation 530, the selected functionality or attribute is automatically applied to the object, data item or data range.

After application of the functionality or attribute, at operation 535, the split button user interface component is automatically updated wherein the visualization 210 representative of the functionality or attribute last applied is updated accordingly. For example, if the last functionality applied were to apply a bar graph style to a set of data, then a visualization representing a bar graph may be automatically displayed in the executable section of the split button user interface component. As described above, in addition, a text string that may be provided either in the executable section or the menu section of the split button user interface component may be updated to provide a descriptive text string, for example “Bar Graph”, associated with the last used functionality or attribute. In addition, if the split button user interface component in use contains a plurality of selectable functionality icons, for example, a set of most frequently used functionality icons, a set of most popular functionality icons, or a combination of last used, most frequently used, most popularly used, and the like, then the displayed selectable icons will be updated accordingly.

At operation 540, a second object, data item or data range is selected for application of the last or previously used functionality or attribute. At operation 545, a selection of the executable section of the split button user interface component is received, and at operation 550 the last used functionality associated with the split button user interface component is automatically applied to the object, data item or data range, as desired. The method 500 may then conclude at end operation 595. Thus, the user is not required to launch the menu or gallery a second time for searching for and selecting the desired functionality or attribute. The usability of the associated software application is improved for the user, and the efficiency of the computing device is increased while simultaneously wear and tear on the computing device is decreased.

While the example aspects have been described in the general context of program modules that execute in conjunction with an application program that runs on an operating system on a computer, those skilled in the art will recognize that split buttons with access to previously used options may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 6-8 and the associated descriptions provide a discussion of a variety of operating environments in which aspects may be practiced. However, the devices and systems illustrated and discussed with respect to FIGS. 6-8 are for purposes of example and illustration and are not limiting of a vast number of computing device configurations that may be utilized for practicing aspects described herein.

FIG. 6 is a block diagram illustrating physical components (i.e., hardware) of a computing device 600 with which aspects may be practiced. The computing device components described below may be suitable for the client devices 105 described above with reference to FIGS. 1-5. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 650. The operating system 605, for example, may be suitable for controlling the operation of the computing device 600. Furthermore, aspects may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

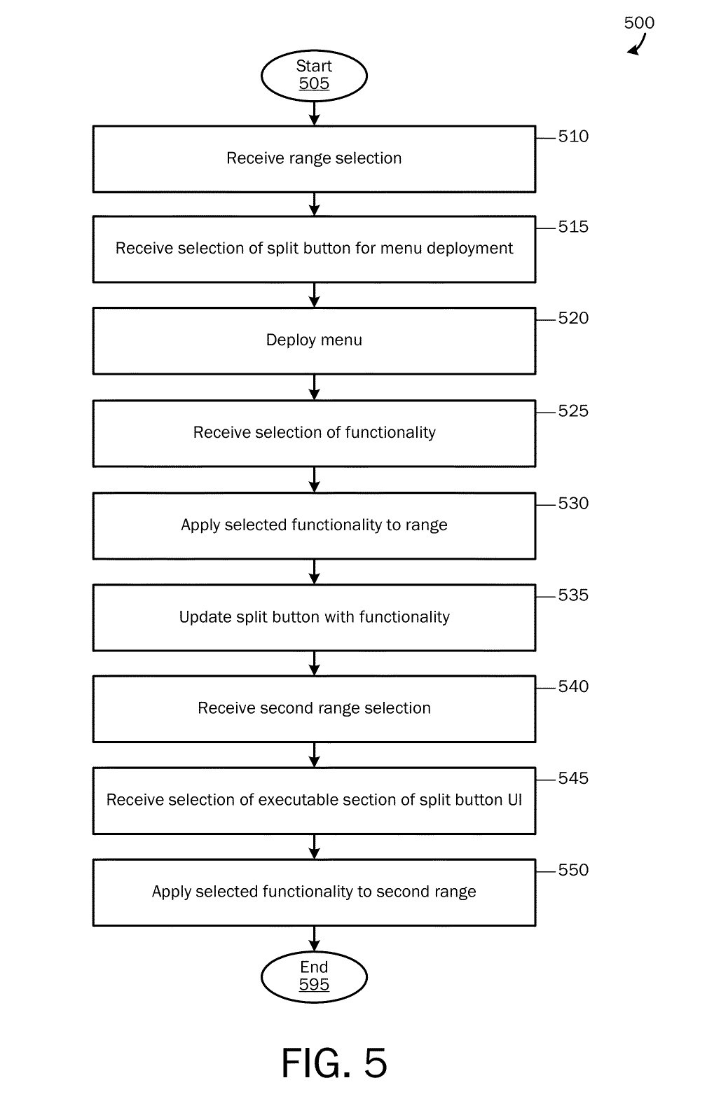

As stated above, a number of program modules, including the split button provision module 430, and data files may be stored in the system memory 604. While executing on the processing unit 602, the program modules 606 may perform processes including, but not limited to, one or more of the stages of the method 500 illustrated in FIG. 5. Other program modules that may be used in accordance with aspects and may include applications such as electronic mail and contacts applications, word processing applications, spreadsheet applications, database applications, slide presentation applications, drawing or computer-aided application programs, etc.

Furthermore, aspects may be practiced in an electrical circuit comprising discrete electronic elements, packaged or integrated electronic chips containing logic gates, a circuit utilizing a microprocessor, or on a single chip containing electronic elements or microprocessors. For example, aspects may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 600 on the single integrated circuit (chip). Aspects may also be practiced using other technologies capable of performing logical operations such as, for example, AND, OR, and NOT, including but not limited to mechanical, optical, fluidic, and quantum technologies. In addition, aspects may be practiced within a general purpose computer or in any other circuits or systems.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 7A and 7B illustrate a mobile computing device 700, for example, a mobile telephone, a smart phone, a tablet personal computer, a laptop computer, and the like, with which aspects may be practiced. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or fewer input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates peripheral device ports 745, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (i.e., an architecture) 702 to implement some aspects. In one aspect, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 750, including the split button provision module 430, may be loaded into the memory 762 and run on or in association with the operating system 764. Examples of the application programs include phone dialer programs, electronic communication applications, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

The visual indicator 720 may be used to provide visual notifications and/or an audio interface 774 may be used for producing audible notifications via the audio transducer 725. In the illustrated aspect, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. Accordingly, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

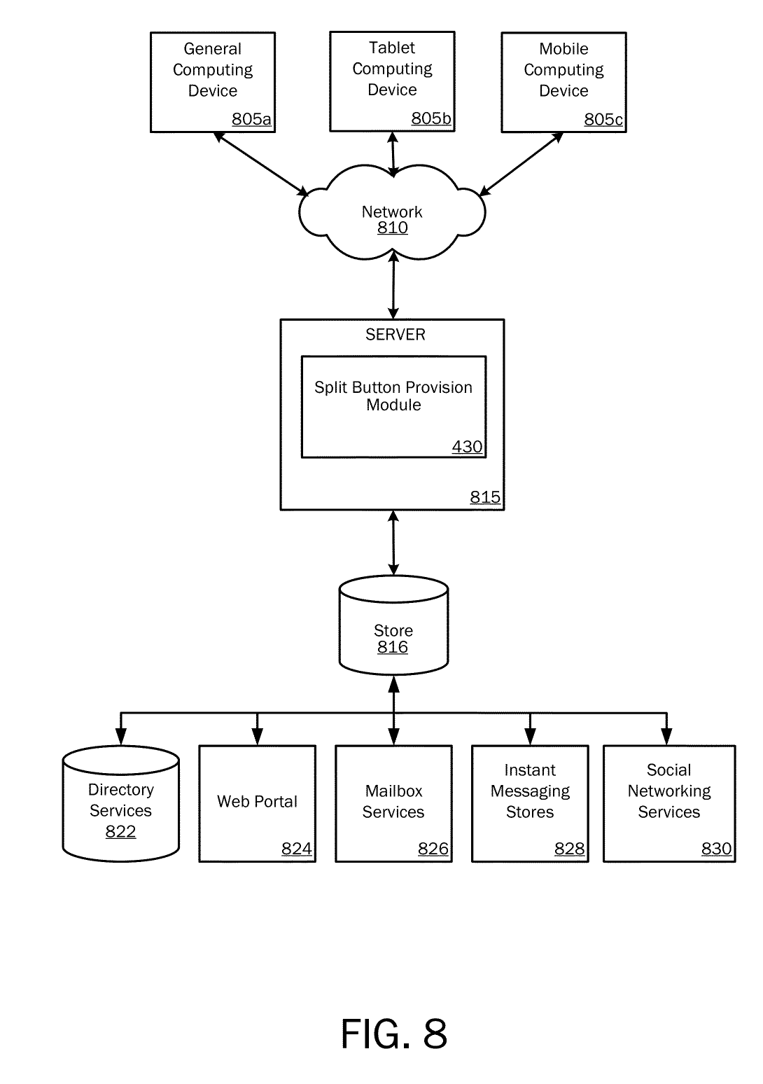

FIG. 8 illustrates one aspect of the architecture of a system for providing the functionality described herein across components of a distributed computing environment. Content developed, interacted with, or edited in association with the applications described above may be stored in different communication channels or other storage types. For example, various documents may be stored using a directory service 822, a web portal 824, a mailbox service 826, an instant messaging store 828, or a social networking site 830. The applications may use any of these types of systems or the like for providing the functionalities described herein across multiple workloads, as described herein. A server 815 may provide the functionality to clients 805A-C and 105. As one example, the server 815 may be a web server providing the application functionality described herein over the web. The server 815 may provide the application functionality over the web to clients 805A-C and 105 through a network 810. By way of example, a client computing device 105 may be implemented and embodied in a personal computer 805A, a tablet computing device 805B and/or a mobile computing device 805C (e.g., a smart phone), or other computing device. Any of these aspects of the client computing device may obtain content from the store 816.

Aspects of the present disclosure, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the present disclosure as claimed in any way. The aspects, examples, and details provided in this application are considered sufficient to convey possession and enable others to make and use the best mode of the present disclosure. The present disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the present disclosure.

We claim:

1. A system for providing a split button user interface comprising:
one or more device operating components including a processor, and a memory including instructions, which when executed provide:
a display module, operable to, in response to receiving selection of a document object within an application, render and display user interface components within a user interface of the application via a display screen in communication with the system;
a split button provision module, operable to provide the split button user interface within the user interface, the split button user interface comprising a selectable function execution section and a selectable menu section;
wherein the selectable function execution section includes a visualization of a designated function and is operable, on selection, to automatically apply the designated function to the selected document object within the application; and
wherein the selectable menu section is operable to provide a gallery of functions that are selectable to be applied to the selected document object, and wherein selecting a function from the gallery of functions dismisses the gallery of functions, updates the designated function displayed in the selectable function executable section, and applies the designated function to the selected document object.

2. The system of claim 1, wherein the selectable menu section includes a directional indicator operable to indicate a direction, relative to the split button user interface, in which the gallery of functions will be provided.

3. The system of claim 1, wherein the display module is further operable to track a display space of the display screen to determine whether to provide the user interface according to a ribbon-style array of user interface components or a palette of user interface components.

4. The system of claim 1, wherein the split button provision module is further operable to transform a non-split button user interface into the split button user interface in response to selecting of a function from a gallery provided by the non-split button user interface.

5. The system of claim 1, wherein the split button provision module is further operable to demote the split button user interface to a non-split button user interface in response meeting to a non-use threshold.

6. The system of claim 1, wherein the split button provision module is further operable to include a text string in the split button user interface, wherein the text string is descriptive of the designated function.

7. The system of claim 1, wherein the function execution section includes a plurality of designated functions, each of the plurality of designated functions having an associated visualization, wherein the associated visualizations are operable to be selected to automatically apply the associated designated functions to the selected document object.

8. The system of claim 1, wherein the plurality of designated functions are set according to at least one of:
a last used function by a user;
a most frequently used function based on a user history; and
a popular function based on a plurality of user histories.

9. A method for providing a split button user interface, comprising:
receiving selection of a first document object;
in response to receiving selection of the first document object, providing in a computer-generated user interface, a selectable user interface component having a selectable menu section and a selectable function execution section;
in response to receiving selection of the selectable menu section, providing a menu of functions operable to be applied to a document object;
in response to receiving selection of a function from the menu of functions, dismissing the provided menu of functions, and automatically applying the selected function to the first document object;
displaying in the selectable function execution section a visualization of the selected function illustrating the selected function applied to the first document object;
receiving selection of a second document object; and
in response to receiving selection of the function execution section, automatically applying the selected function to the second document object without provision of the menu of functions.

10. The method of claim 9, further comprising providing a plurality of functions via the selectable function execution section, wherein each of the plurality of functions is operable to be applied to the second document object without provision of the menu of functions.

11. The method of claim 10, wherein one of the plurality of functions provided via the selectable function execution section includes a most frequently used function from the menu of functions, wherein the most frequently used function is determined based on a prior user history.

12. The method of claim 10, wherein one of the plurality of functions provided via the selectable function execution section includes a most popular function from the menu of functions, wherein the most popular function is determined based on a combined user history of a plurality of user.

13. The method of claim 9, further comprising
determining a display space of a device providing the split button user interface;
determining whether to display the split button user interface in a ribbon-style array of user interface components or a palette of user interface components based on the display space;
when it is determined to display the split button user interface in the ribbon-style array of user interface components, displaying the split button user interface in the ribbon-style array of user interface components and, in response to receiving a decrease in the display space, displaying the split button user interface in the palette of user interface components; and
when it is determined to display the split button user interface in the palette of user interface components, displaying the split button user interface in the palette of user interface components and, in response to receiving an increase in the display space, displaying the split button user interface in the ribbon-style array of user interface components.

14. The method of claim 9, wherein the selectable menu section includes a text string descriptive of the menu of functions, further comprising:
in response to receiving selection of the function from the menu of functions, updating the text string to be descriptive of the selected function, and changing an orientation of the split button user interface to include the text string in the function execution section.

15. The method of claim 9, wherein the split button user interface is initially presented as a non-split button user interface comprising the menu section, further comprising transforming the non-split button user interface to include the selectable function execution section in response to dismissing the provided menu of functions.

16. The method of claim 9, further comprising
demoting the split button user interface into a non-split button user interface comprising the menu section, wherein the visualization of the selected function is removed.

17. The method of claim 9 wherein the selectable menu section includes a directional indicator, wherein the directional indicator indicates a location in a user interface that the menu of functions is to be provided when the selectable menu section is selected.

18. A computing device for providing a split button user interface, comprising:
a processor;
a memory storage including instructions, which when executed by the processor cause the computing device to be operable to:
provide a non-split button user interface as a component of a user interface of an application, wherein the non-split button user interface is operable to provide a menu of functions to apply to a first selection of content within the application;
in response to receiving a selection of a function from the menu of functions, dismiss the menu of functions and automatically apply the selected function to a selection of content;
in response to dismissing the menu of functions, transform the non-split button user interface into a split button user interface, wherein the split button user interface includes a selectable menu section, operable to provide the menu of functions, and a selectable function execution section, operable to, on selection, apply the selected function to a second selection of content without provision of the menu of functions, wherein the selectable function execution section includes a visualization reflective of the selected function.

19. The computing device of claim 18, wherein the selectable menu section of the split button user interface includes a directional indicator operable to indicate a direction, relative to the split button user interface, in which the menu of functions will be provided.

20. The computing device of claim 18, further operable to provide the split button user interface as a user interface component in a ribbon-style array or a palette of user interface components, wherein the ribbon-style array or the palette is chosen to provide the user interface components, including the split button user interface, based on a display space of a display device associated with the computing device.
